(19) United States
(12) Patent Application Publication
(10) Pub. No.: US 2005/0088305 A1
(43) Pub. Date: Apr. 28, 2005

(54) Identification apparatus

(75) Inventors: Charles Greene, Pittsburgh, PA (US); Muhammad Rahim, Monroeville, PA (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(73) Assignee: Mobile Aspects

(21) Appl. No.: 10/691,082

(22) Filed: Oct. 22, 2003

(51) Int. Cl. G08B 13/14

(52) U.S. Cl. 340/572.7; 340/825.49; 340/5.92; 235/385

(57) ABSTRACT

Disclosed is an identification apparatus for use in connection with multiple discrete identity source elements positioned in an identification apparatus signal identification area. The identification apparatus includes at least one signal receiving mechanism for receiving a signal emitted from the identity source elements. The signal receiving mechanism has a field of detection of at least a portion of the identification apparatus signal identification area. Further, the signal receiving mechanism is capable of moving along an axis of movement. A control mechanism is in communication with the signal receiving mechanism. Further, the control mechanism can control the movement of the signal receiving mechanism along the axis of movement and/or receive, process and transmit the signal received by the signal receiving mechanism. A method of receiving a signal from identity source elements positioned in a single identification area is also disclosed.

### BACKGROUND OF THE INVENTION

1. Field of the Invention

The present invention relates generally to identification apparatus and devices for gathering data regarding a plurality of objects or items and, in particular, to an identification apparatus that is useful in identifying stationary objects, items, tags and the like regardless of orientation.

2. Description of Related Art

In order to track and gather data regarding objects, such as items, products, individuals, cars, etc., radio frequency (RF) identification technology allows for the accurate tracking of the objects in the system. Typically, the object or objects will have an identification source or tag associated therewith, and this tag provides a unique identification to the object or individual. A receiving unit, typically in the form of an antenna, interacts with the tags and receives signals for further processing. After the signal is received, a control mechanism or other device processes the signal and identifies the object or individual based upon the signal content and source tag.

In many radio frequency identification (RF/ID) applications, a stationary antenna or receiver is used in connection with a moving object. For example, if items are moving along a conveyor belt, they are positioned such that they move past the antenna for identification. Similarly, an appropriately tagged car may drive by an antenna on a toll road. In these examples, the tag or identification source is moving, while the receiver or antenna is stationary.

However, problems arise when the tagged objects are static or stationary. In these situations, the object, and therefore the tag, may be positioned in an orientation that is unfavorable or detrimental to the RF/ID powering and communicating process. These inappropriately oriented tags have a low probability of being identified by the reader or antenna, which causes errors and other malfunctions in the system.

Presently, this orientation problem is solved by using multiple antennae. Specifically, a switching network is used to switch between these antennae, moving the location of the powering and communicating reader. While such a multiple antenna system has solved certain drawbacks, such a system also has numerous limitations. First, since there are a fixed number of antennae, there is only a discrete number of positions for the powering/communicating antennae. Such positions will not guarantee that a tag will be in an operable powering/communicating position. Second, the increased number of antennae will require a complicated and sophisticated controller for switching the location of the powering/communicating antenna. In addition, such multiple-antennae systems are more complicated and require a more sophisticated controller and electronics. Still further, there will be an increase in the number of cables for communication and radio frequency power. Multi-antenna systems also require more complicated and extensive tuning, since each antenna in the system must be tuned using a matching circuit. Increased number of antennae will require more tuning circuits and the large number of antennae in close proximity may make it difficult to tune, which may require each tuning board to have different value components.

### SUMMARY OF THE INVENTION

It is, therefore, an object of the present invention to provide an identification apparatus that overcomes the deficiencies of the prior art. It is another object of the present invention to provide an identification apparatus that is useful in identifying stationary objects. It is a still further object of the present invention to provide an identification apparatus that is able to receive information from an object regardless of its position. It is yet another object of the present invention to provide an identification apparatus that does not require multiple antennae. It is still another object of the present invention to provide an identification apparatus that is more easily tunable than prior art systems.

The present invention is an identification apparatus for use in connection with multiple discrete identity source elements that are positioned in an identification apparatus signal identification area. The identification apparatus includes at least one signal receiving mechanism for receiving a signal emitted from the identity source elements. This signal receiving mechanism has a field of detection that includes at least a portion of the apparatus signal identification area. Further, the signal receiving mechanism moves along an axis of movement. The identification apparatus further includes a control mechanism in communication with the signal receiving mechanism. The control mechanism controls the movement of the signal receiving mechanism along the axis of movement and/or receives, processes and/or transmits the signal received by the signal receiving mechanism.

The present invention is also directed to a method of receiving a signal from at least one of multiple identity source elements positioned in a signal identification area. This method includes the steps of: (a) moving a signal receiving mechanism along at least one axis of movement; (b) receiving a signal emitted by at least one of the plurality of identity source elements by the signal receiving mechanism; and (c) controlling the movement of the signal receiving mechanism by a control mechanism.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1 is a schematic view of a radio frequency identification system according to the prior art;

FIG. 2 is a further schematic view of the prior art system of FIG. 1;

FIG. 3 is a schematic view of a multiple antenna identification system according to the prior art; and

FIG. 4 is a schematic view of an identification apparatus according to the present invention.

### DESCRIPTION OF THE PREFERRED EMBODIMENTS

For purposes of the description hereinafter, the terms “upper”, “lower”, “right”, “left”, “vertical”, “horizontal”, “top”, “bottom” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

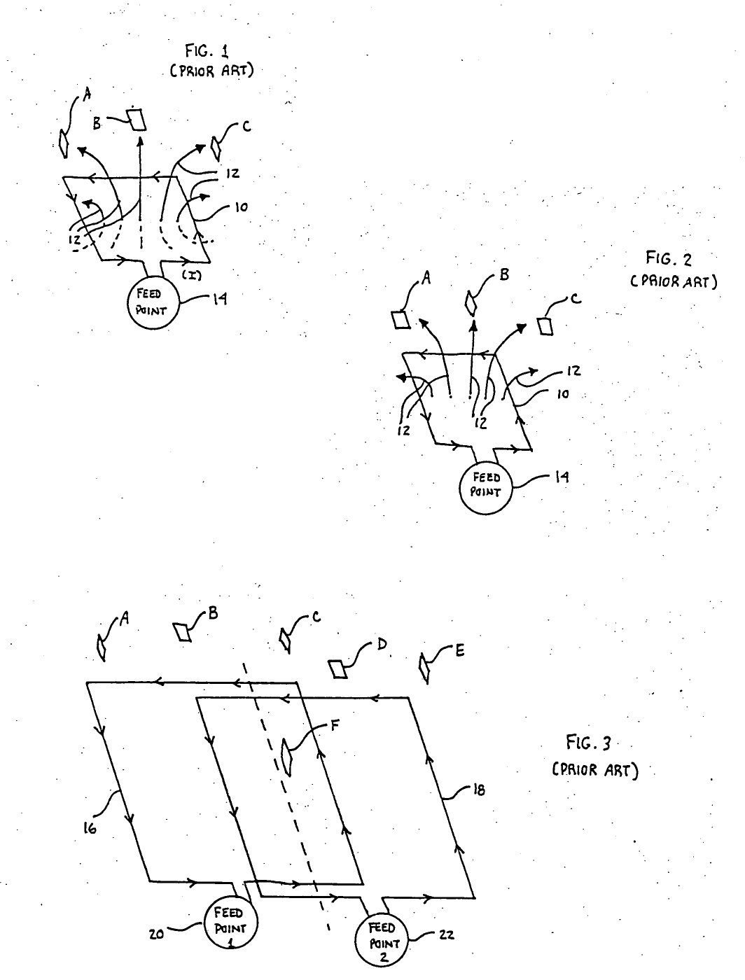

According to the prior art, as illustrated in FIGS. 1 and 2, an antenna 10 is used to project signals 12 that communicate with and power tags A, B and C. Current (I) is directed through the antenna 10 via a feed point 14. Further, the antenna 10 is a generally planar antenna, such that the signals 12 are emitted in the directions illustrated in FIGS. 1 and 2.

Specifically with respect to FIG. 1, when tags A, B and C are oriented as illustrated, the signals 12 are effectively communicated to the tags A, B and C, since the signals 12 are oriented transverse or substantially perpendicular to the face of the tags A, B and C. Therefore, when the tags A, B, C are oriented as shown in FIG. 1, the prior art system is effective, since the antenna 10 is capable of communicating with and identifying all of the tags A, B, C.

However, as seen in FIG. 2, when the tags A, B, C are oriented in a position ninety degrees with respect to the positioning in FIG. 1, the signals 12 from the antenna 10 cannot effectively read or identify tags A, B, C. Since it is the edge portion of tags A, B, C that the signal intercepts, effective and accurate reading is not possible. This means that if a person places an object (not shown) having the tag A, B, C attached thereto in such a position, the item or object would not be identified by this prior art system.

FIG. 3 illustrates one prior art solution that attempts to overcome this deficiency. In this system, tags A, B, C, D, E, F are placed at various positions in the antenna 10 field of detection (the area that the signals 12 are acting upon). This prior art system is a multiple antenna system, in this case having a first antenna 16 and a second antenna 18. The first antenna 16 and the second antenna 18 overlap and are powered through a first feed point 20 and a second feed point 22. In addition, a switching system (not shown) is used to move the location of the powering/communicating antenna from the first antenna 16 to the second antenna 18 and vice versa.

Since the first antenna 16 and the second antenna 18 are switching, tags A, B, C, D, E are identified by either the first antenna 16 or the second antenna 18. However, due to the powering of the antennae, their relative positioning and the location of the first antenna 16 and the second antenna 18 in the system, tag F would still not be read by either the first antenna 16 or the second antenna 18. Therefore, while such a multiple antenna system would certainly capture most of the tags, namely tags A-E, it would not pick up tag F, thereby making the system, while “mostly” accurate, not wholly so. Therefore, the need remains for the ability to pick up all tags A-F regardless of their relative positioning in the system and with respect to the antennae 10, 16, 18.

Accordingly, the present invention is an identification apparatus 100 for use in connection with multiple and discrete identity source elements 102, such as tags A-F. As discussed-above, these tags A-F, or identity source elements 102, are typically connected to or in operative communication with an object or item 103 that is the object of identity. Further, the identity source elements 102 and corresponding items 103 are placed in an identification apparatus signal identification area. In one preferred and non-limiting embodiment, the object or item 103 is a medical item, a container of medicine, a medical device, a hospital-related item, etc. In addition, the signals emitted by the identity source elements 102 include a characteristic unique to either the item 103 or a group of related items 103. It is further envisioned that the identity source elements 102 can be tags or labels that are affixed to the item 103 and emit a unique signal corresponding to the item 103.

A signal receiving mechanism 104 emanates and receives a signal that is emitted from one or more of the identity source elements 102. In addition, the signal receiving mechanism 104 includes a field of detection that is in at least a portion of the identification apparatus signal identification area. Further, and as contemplated in the art, the signal receiving mechanism 104 is typically an antenna that is capable of transmitting and receiving signals and powering and communicating with the identity source elements 102, which are typically referred to as tags A-F. In addition, when the signal receiving mechanism 104 is an antenna, this antenna is capable of receiving radio frequency signals emitted from the identity source elements 102. Further, in this arrangement, the identity source elements 102 are radio frequency identification transponders.

As opposed to using multiple antennae 10, 16, 18 as in the prior art, the present invention and identification apparatus 100 uses a moving signal receiving mechanism 104. This means that the signal receiving mechanism 104 is able to move along at least one axis of movement (X, Y, Z). Further, a control mechanism 106 is in communication with the signal receiving mechanism 104 and is able to control the movement of the signal receiving mechanism 104 along the axis of movement (X, Y, Z). Further, it is also envisioned that the control mechanism 106 is capable of receiving, processing and/or transmitting the signals received by the signal receiving mechanism 104. It is also envisioned that the signal receiving mechanism 104 does not simply traverse one direction along the axis of movement (X, Y, Z), and instead moves back and forth along this axis at a standard period, rate or other parameter, as controlled through the control mechanism 106.

In order to power and provide current to the signal receiving mechanism 104, a feed mechanism 108 is used. Similarly, in order to move the signal receiving mechanism 104 along an axis of movement (X, Y, Z), a drive mechanism 110 is in operative communication with the signal receiving mechanism 104. The control mechanism 106 is therefore in communication with the drive mechanism 110, the signal receiving mechanism 104 and/or the feed mechanism 108. The control mechanism 106 provides a user of the identification apparatus 100 with optimal control over the system, the powering of the identity source elements 102, the communication between the signal receiving mechanism 104 and the identity source elements 102, the movement of the signal receiving mechanism 104, the operation of the signal receiving mechanism 104 and other similar variables and controllable components in the system.

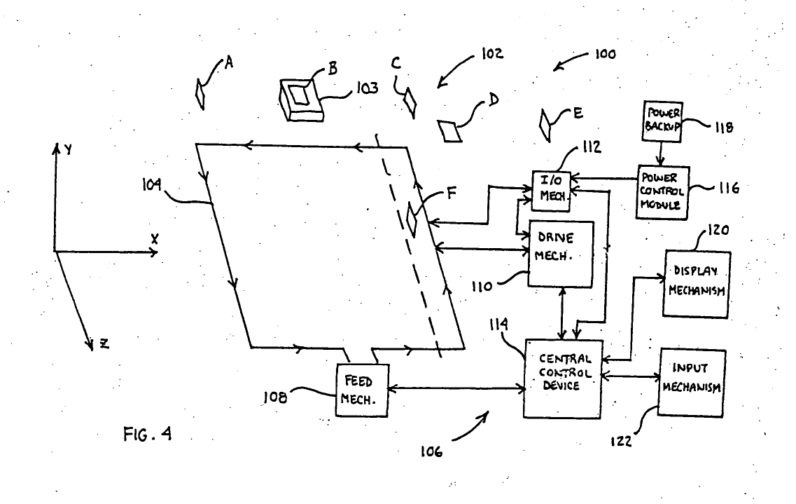

As seen in the preferred and non-limiting embodiment of FIG. 4, the signal receiving mechanism 104 moves in an axis of movement, namely the X-axis of movement. With reference to tags A-F, as shown in identical positions in both FIG. 3 (prior art) and FIG. 4, the signal receiving mechanism 104 will power, communicate with and receive signals from all of the identity source elements 102, namely all of tags A-F. This occurs since, while the signal receiving mechanism 104 may not pick up one or more of tags A-F in a first position as the signal receiving mechanism 104 moves back and forth across the axis of movement, the signals 12 emanating from the signal receiving mechanism 104 will appropriately contact, power and communicate with each identity source element 102 at at least one point in time. While the exemplary embodiment is showing the signal receiving mechanism 104 moving in the X-axis of movement, the signal receiving mechanism 104 may also move in various axes of movement, such as the Y-axis and the Z-axis. In addition, multiple signal receiving mechanisms 104 may be used and provide further areas of detection.

Since the signal receiving mechanism 104 is moving, the signal receiving mechanism field of detection moves through the entire identification apparatus signal identification area in a dynamic manner, whereby each and every identification source element 102 is identified. The drive mechanism 102 may be a mechanical motor or other similar device. The result of the movement of the signal receiving mechanism 104 is equivalent to an infinite number of switchable antennae, as described in connection with FIG. 3 of the prior art. Therefore, the present invention provides an identification apparatus 100 that reduces the complexity of the overall system, while increasing the overall accuracy.

In a preferred and non-limiting embodiment, the drive mechanism 110 is a stepper motor, which moves the signal receiving mechanism 104 along a single axis of movement. However, as discussed above, motion along other axes may be provided to provide a three-dimensional result or a second and third antenna can be added to provide powering/communication in these directions. When using multiple signal-receiving mechanisms 104, the control mechanism 106 is capable of selecting the appropriate pairs and otherwise operating all signal-receiving mechanisms 104 in the identification apparatus 100.

In another preferred and non-limiting embodiment, the control mechanism 106 may also include an input/output mechanism 112 that is in communication with the signal receiving mechanism 104 and translates one or more output signals into digital output signals. In addition, in this embodiment, the control mechanism 106 also includes a central control device 114 in communication with the input/output mechanism 112. The central control device 114 receives, processes and otherwise transmits signals for initiating actions based-upon the digital output signal received from the input/output mechanism 112. Further, the control mechanism 106 may also include a power control module 116 that is in communication with the input/output mechanism 112 and provides specified power outputs at specified power levels. In the event of electronic power failure, a backup power module 118 may also be included. As with the power control module 116, the backup power module 118 would be in communication with the input/output mechanism 112 for supplying power in emergency situations.

The central control device 114 may be a programmable microchip, a microcontroller, a personal computer, a hand-held computer, a terminal, a networked computing device, etc. The central control device 114 and/or the control mechanism 106 may also include a control program for receiving, processing and transmitting signals initiating actions based upon signal content. It is further envisioned that the control mechanism 106 may be integral with or in communication with a display mechanism 120. The display mechanism 120 provides a visual display to the user. For example, the visual display may illustrate or otherwise visually inform the user of initiated action, a use history, an item 103 history, a user history, user data, identity source element 102 data, inventory data, item 103 data, identification apparatus 100 data, etc. In order to communicate with the control mechanism 106 and/or the central control device 114, an input mechanism 122 may also be included. The input mechanism 122 receives user input and transmits user input signals to the control mechanism 106 and/or the central control device 114.

It should also be noted that any or all of the feed mechanism 108, input/output mechanism 112, power control module 116, power backup 118, display mechanism 120 and input mechanism 122 may be in communication, both hardwired and wireless, with the central control device 114. In addition, these various components and sub-components are collectively referred to as the control mechanism 106 and may be integrated therewith or stand-alone equipment. For example, in the case of the display mechanism 120, this display mechanism 120 may be a monitor and, for example, the input mechanism 122 may be a keyboard. Still further, all of the components and equipment can be integrated into a single unit or housing and operate as a unified system.

In this manner, the present invention provides an identification apparatus 100 that provides powering/communicating capabilities with identity source element 102, such as an RF/ID tag, regardless of the tag orientation with respect to the antennae. In addition, the present invention provides the realization of three-dimensional tag placement without the need for a large number of antennae. Still further, the present invention provides an identification apparatus 100 that represents an infinite number of discrete antennae and provides increased accuracy by interrogating different tags in their optimal positions at different times. In turn, this allows an increase in the number of identity source elements 102 (and, therefore, the objects to which they are attached) read per area and a decrease in the required space between the identity source elements 102. In addition, the present invention provides an identification apparatus 100 that is less complicated in control, in its electronics usage and is easily tuned.

This invention has been described with reference to the preferred embodiments. Obvious modifications and alterations will occur to others upon reading and understanding the preceding detailed description. It is intended that the invention be construed as including all such modifications and alterations.

1. An identification apparatus for use in connection with a plurality of discrete identity source elements positioned in an identification apparatus signal identification area, the identification apparatus comprising:
at least one signal receiving mechanism configured to receive a signal emitted from at least one of the plurality of identity source elements, the signal receiving mechanism having a field of detection comprising at least a portion of the identification apparatus signal identification area, wherein the at least one signal receiving mechanism is configured to move along at least one axis of movement; and
a control mechanism in communication with the at least one signal receiving mechanism and configured to at least one of:
(i) control the movement of the at least one signal receiving mechanism along the at least one axis of movement; and
(ii) receive, process, and transmit the signal received by the at least one signal receiving mechanism.

2. The identification apparatus of claim 1, wherein the signal receiving mechanism is an antenna configured to receive radio frequency signals emitted from the identity source elements, and wherein the identity source elements are radio frequency identification transponders.

3. The identification apparatus of claim 1, wherein at least one of the identity source elements is in operative communication with at least one item positioned in the identification apparatus signal identification area.

4. The identification apparatus of claim 3, wherein the at least one item is at least one of a medical item, a container of medicine, a medical device and a hospital-related item.

5. The identification apparatus of claim 3, wherein the signals emitted by the identity source elements is a signal having a characteristic unique to one of the at least one item and a group of related items.

6. The identification apparatus of claim 1, wherein the control mechanism further comprises:
an input/output mechanism in communication with the signal receiving mechanism and configured to translate at least one output signal into at least one digital output signal; and
a central control device in communication with the input/output mechanism and configured to receive, process and transmit signals and initiate an action based upon the at least one digital output signal received from the input/output mechanism.

7. The identification apparatus of claim 6, wherein the control mechanism further comprises a power control module in communication with the input/output mechanism and configured to provide specified power outputs at specified power levels.

8. The identification apparatus of claim 7, further comprising a backup power module in communication with the input/output mechanism and configured to supply power in the event of an electronic power failure.

9. The identification apparatus of claim 6, wherein the central control device is one of a programmable microchip, a microcontroller, a personal computer, a hand-held computer, a terminal and a networked computing device.

10. The identification apparatus of claim 1, further comprising a display mechanism in communication with the control mechanism and configured to provide a visual display to a user corresponding to one of an action initiated by the control mechanism, a use history, an item history, a user history, user data, identity source element data, inventory data, item data and identification apparatus data.

11. The identification apparatus of claim 1, further comprising an input mechanism in communication with the control mechanism and configured to receive user input and transmit user input signals to the control mechanism.

12. The identification apparatus of claim 1, wherein the identity source elements are at least one of tags and labels affixed to at least one item and configured to emit a unique signal corresponding to the at least one item.

13. The identification apparatus of claim 1, wherein the control mechanism includes a control program configured to receive, process and transmit signals and initiate actions based upon signal content.

14. The identification apparatus of claim 1, further comprising a feed mechanism in communication with the control mechanism and configured to power the signal receiving mechanism.

15. The identification apparatus of claim 1, further comprising a drive mechanism configured to move the signal receiving mechanism along the axis of movement.

16. The identification apparatus of claim 15, wherein the drive mechanism is a stepper motor.

17. The identification apparatus of claim 15, wherein the drive mechanism motivates the signal receiving mechanism to move back and forth along the axis of movement, the operation of the drive mechanism controlled by the control mechanism.

18. A method of receiving a signal from at least one of a plurality of identity source elements positioned in a signal identification area, comprising the steps of:
(a) moving a signal receiving mechanism along at least one axis of movement;
(b) receiving a signal emitted by at least one of the plurality of identity source elements by the signal receiving mechanism; and
(c) controlling the movement of the signal receiving mechanism by a control mechanism.

19. The method of claim 18, further comprising the step of positioning at least one identity source element in operative communication with at least one item.

20. The method of claim 19, further comprising the step of positioning the at least one item in a identification apparatus signal identification area.

21. The method of claim 19, wherein the at least one item is at least one of a medical item, a container of medicine, a medical device and a hospital-related item.

22. The method of claim 18, wherein the controlling step is performed by one of a programmable microchip, a microcontroller, a personal computer, a hand-held computer, a terminal and a networked computing device.

23. The method of claim 18, further comprising the step of visually displaying to a user at least one of an action initiated by the control mechanism, a use history, an item history, a user history, user data, identity source element data, inventory data, item data and identification apparatus data.

24. The method of claim 18, wherein the identity source elements are at least one of tags and labels affixed to at least one item and configured to emit a unique signal corresponding to the at least one item.

25. The method of claim 18, further comprising the step of powering the signal receiving mechanism.

26. The method of claim 18, wherein the step of moving the signal receiving mechanism along the axis of movement is accomplished by a drive mechanism.

27. The method of claim 26, wherein the drive mechanism is a stepper motor.

28. The method of claim 18, further comprising the step of moving the signal receiving mechanism back and forth along the axis of movement.
